(19) United States
(12) Patent Application Publication
(10) Pub. No.: US 2024/0310806 A1
(43) Pub. Date: Sep. 19, 2024

(54) SYSTEM CONSTRUCTION ASSISTANCE DEVICE, SYSTEM CONSTRUCTION ASSISTANCE DEVICE OPERATION METHOD, AND RECORDING MEDIUM

(71) Applicant: Mitsubishi Electric Corporation, Tokyo (JP)

(72) Inventor: Tokiharu MIYOSHI, Tokyo (JP)

(73) Assignee: Mitsubishi Electric Corporation, Tokyo (JP)

(21) Appl. No.: 18/575,305

(22) PCT Filed: Sep. 28, 2021
(86) PCT No.: PCT/JP2021/035506

§ 371 Date: Dec. 29, 2023

(51) Int. Cl. G05B 19/05

(52) U.S. Cl. CPC G05B 19/058

(57) ABSTRACT

An engineering tool includes a current consumption information storage, a receiver, and a display. The current consumption information storage stores a value of a current consumed by a unit included in a programmable logic controller or PLC and having a function that is capable of being disabled. The value of the current is a value of a current consumed by the unit with the function being disabled. The receiver receives an operation for disabling the function. The display acquires, from the current consumption information storage, the value of the current consumed by the unit with the function being disabled and displays the acquired value.

### TECHNICAL FIELD

The present disclosure relates to a system construction assistance device, a system construction assistance device operation method, and a program.

### BACKGROUND ART

Devices for automating production processes are used at factories. Such devices are controlled by a system including a programmable logic controller (PLC).

The system includes multiple units, such as a base unit, a power supply unit, and a functional unit. The power supply unit provides a current to other units in the system. The maximum value of a current supplied by each model of the power supply unit is predetermined as the corresponding maximum rated current.

The user of the system selects a power supply unit with a maximum rated current being greater than or equal to the total value of power consumed by the units in the system.

Multiple functional units, each with a single function, are combined into a complex system by a method referred to as a building-block method. With a known building-block method, the system may simply include functional units with intended functions to allow the user to easily match the maximum rated current of the power supply unit with the total value of power consumed by all these functional units in the system.

The recent functional units have more sophisticated functions. Each functional unit may have multiple functions. Patent Literature 1 describes a system construction assistance device for displaying the specifications of each unit having multiple functions.

### CITATION LIST

### Patent Literature

Patent Literature 1: International Publication No. WO 2019/193752

### SUMMARY OF INVENTION

### Technical Problem

The system construction assistance device described in Patent Literature 1 does not include means for enabling or disabling each function in the units.

In such a system, the value of rated current consumption in each unit having the multiple functions is predetermined based on the value of the current consumed by the corresponding unit when all the multiple functions are enabled.

The user of the system still selects a power supply unit with a rated current being greater than or equal to the total value of power consumed by all the units in the system when all the multiple functions are enabled although some functions are not to be enabled.

Thus, with the known system construction assistance device, the user may not easily select a power supply unit as appropriate for a current consumed simply by the functions to be enabled.

In response to the above circumstances, an objective of the present disclosure is to provide a system construction assistance device, a system construction assistance device operation method, and a program to allow the user to easily select a power supply unit as appropriate for a current consumed simply by the functions to be enabled.

### Solution to Problem

To achieve the above objective, a system construction assistance device according to an aspect of the present disclosure includes a current consumption information storage, a receiver, and a display. The current consumption information storage stores a value of a current consumed by a unit included in a programmable logic controller and having a function that is capable of being disabled. The value of the current is a value of a current consumed by the unit with the function being disabled. The receiver receives an operation for disabling the function. The display displays the value of the current consumed by the unit with the function being disabled. The value is acquired from the current consumption information storage.

### Advantageous Effects of Invention

The system construction assistance device, the system construction assistance device operation method, and the program according to the above aspect of the present disclosure allow a user to easily select a power supply unit as appropriate for a current consumed simply by the functions to be enabled.

### BRIEF DESCRIPTION OF DRAWINGS

FIG. 1 is a diagram of an overall engineering tool and an overall programmable logic controller (PLC) according to Embodiment 1 of the present disclosure;

FIG. 2 is a diagram describing the details of the PLC illustrated in FIG. 1;

FIG. 3 is a diagram of the details of the engineering tool illustrated in FIG. 1;

FIG. 4 is a table of specific example information to be stored in a current consumption information storage in the engineering tool illustrated in FIG. 3;

FIG. 5 is a flowchart of a procedure for operating the engineering tool illustrated in FIG. 3 to operate the PLC;

FIG. 6 is a flowchart of the details of a processing step included in the flowchart illustrated in FIG. 5 for selecting a power supply unit, a functional unit, and a controller to be incorporated in the PLC, and a function for use;

FIG. 7 is a diagram of specific example information to be displayed on a display in the engineering tool illustrated in FIG. 3;

FIG. 8 is a diagram of other specific example information to be displayed on the display in the engineering tool illustrated in FIG. 3;

FIG. 9 is a diagram of other specific example information to be displayed on the display in the engineering tool illustrated in FIG. 3;

FIG. 10 is a diagram of other specific example information to be displayed on the display in the engineering tool illustrated in FIG. 3;

FIG. 11 is a diagram of other specific example information to be displayed on the display in the engineering tool illustrated in FIG. 3;

FIG. 12 is a diagram of other specific example information to be displayed on the display in the engineering tool illustrated in FIG. 3;

FIG. 13 is a diagram of other specific example information to be displayed on the display in the engineering tool illustrated in FIG. 3;

FIG. 14 is a diagram of other specific example information to be displayed on the display in the engineering tool illustrated in FIG. 3;

FIG. 15 is a diagram of other specific example information to be displayed on the display in the engineering tool illustrated in FIG. 3;

FIG. 16 is a diagram of other specific example information to be displayed on the display in the engineering tool illustrated in FIG. 3;

FIG. 17 is a diagram of other specific example information to be displayed on the display in the engineering tool illustrated in FIG. 3;

FIG. 18 is a diagram of other specific example information to be displayed on the display in the engineering tool illustrated in FIG. 3;

FIG. 19 is a diagram describing an engineering tool according to Embodiment 2;

FIG. 20 is a diagram describing the details of a PLC to be connected to the engineering tool illustrated in FIG. 19;

FIG. 21 is a table of specific example information to be stored in a storage in an engineering tool according to a modification;

FIG. 22 is a diagram describing the details of a PLC to be connected to the engineering tool in the modification; and

FIG. 23 is a diagram of a specific example hardware configuration in the engineering tool illustrated in FIGS. 3 and 19.

### DESCRIPTION OF EMBODIMENTS

### Embodiment 1

An engineering tool 100 according to Embodiment 1 of the present disclosure is described below with reference to the drawings.

### Overview of Engineering Tool 100

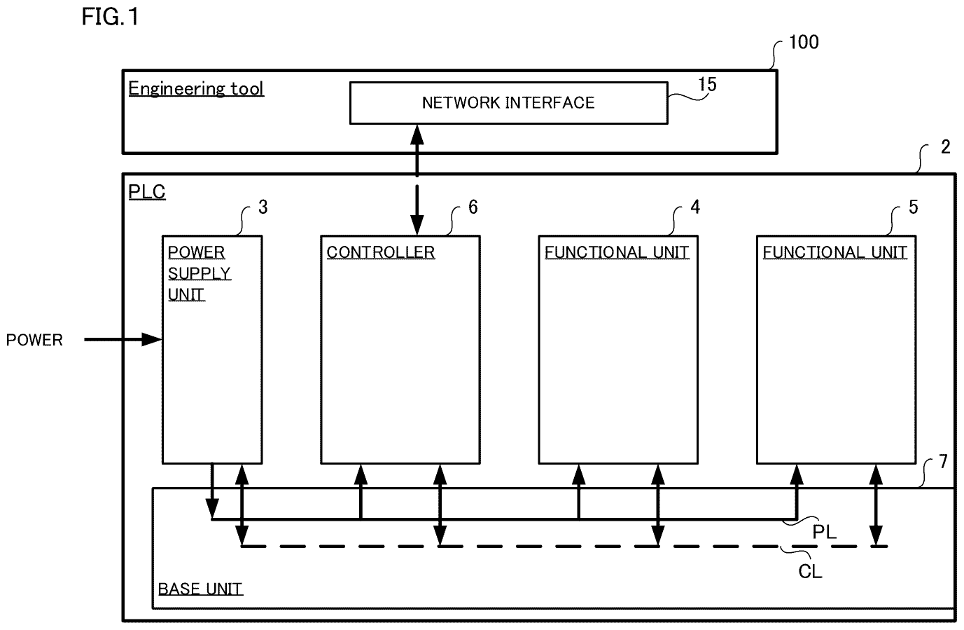

The engineering tool 100 illustrated in FIG. 1 is connected to a programmable logic controller (PLC) 2 including a functional unit 4, a functional unit 5, and a controller 6. The functions in these units are capable of being disabled. The engineering tool 100 sets whether to use each of these functions.

Examples of the engineering tool 100 include a personal computer (PC), a smartphone, and a tablet terminal each including application software being installed. The engineering tool 100 is an example of a system construction assistance device.

### Overview of PLC 2

For ease of understanding, the PLC 2 described below includes all components being prepared and assembled together.

The PLC 2 includes a power supply unit 3 for receiving power from an external source to supply a current to the entire PLC 2, the functional units 4 and 5 for implementing a specific function for each model, the controller 6 for controlling the functional units 4 and 5, and a base unit 7 in which the power supply unit 3, the controller 6, and the functional units 4 and 5 are installed.

A power line PL to receive the current supplied from the power supply unit 3 and a communication line CL to receive data transmitted from the functional unit 4, the functional unit 5, or the controller 6 are installed on the base unit 7.

The functional units 4 and 5 are connected to the power supply unit 3 with the power line PL and are connected to the controller 6 with the communication line CL.

### Configuration of Power Supply Unit 3

The power supply unit 3 of each model has predetermined rated current consumption RC. The value of rated current consumption RC is predetermined by, for example, the manufacturer as an upper limit of a current for ensuring a normal operation of the corresponding power supply unit 3.

### Configuration of Functional Units 4 and 5

Each of the functional unit 4 and the functional unit 5 has the configuration described below.

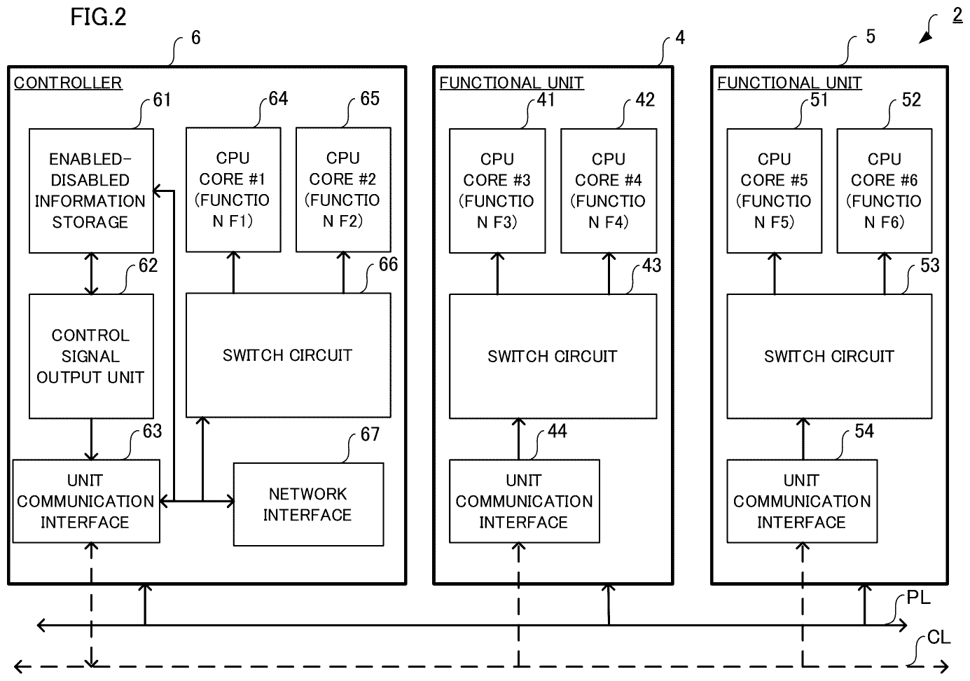

FIG. 2 illustrates the detailed configuration of the functional units 4 and 5 and the controller 6 that are included in the PLC 2 illustrated in FIG. 1.

To describe the relationship between the functions in the functional units 4 and 5 and the control performed by the controller 6, the functional unit 4 may include an information processing function F3 and a control processing function F4. The functional unit 5 may include an artificial intelligence (AI) processing function F5 and an input-output processing function F6. The functional unit 4 may include two central processing unit (CPU) cores 41 and 42 for performing general arithmetic and logic operations. The functional unit 5 may include two CPU cores 51 and 52 for performing general arithmetic and logic operations. The CPU core 41 implements the information processing function F3. The CPU core 42 implements the control processing function F4. The CPU core 51 implements the AI processing function F5. The CPU core 52 implements the input-output processing function F6.

The functional unit 4 includes a switch circuit 43 for switching between supplying and blocking of the current to the CPU cores 41 and 42. The switch circuit 43 detects, through a unit communication interface 44, a signal output from the controller 6 to the communication line CL, and switches connection between the power line PL and each of the CPU cores 41 and 42.

Similarly, the functional unit 5 includes a switch circuit 53 for switching between supplying and blocking of the current to the CPU cores 51 and 52. The switch circuit 53 detects, through a unit communication interface 54, a signal output from the controller 6 to the communication line CL, and switches connection between the power line PL and each of the CPU cores 51 and 52.

### Configuration of Controller 6

The controller 6 has the configuration described below.

Similarly to the functional units 4 and 5, the controller 6 includes a logging processing function F1 and a timer processing function F2. The controller 6 includes a CPU core 64 for implementing the logging processing function F1, a CPU core 65 for implementing the timer processing function F2, and a switch circuit 66 for switching between supplying and blocking of the current to the CPU cores 64 and 65.

The controller 6 further includes an enabled-disabled information storage 61 for storing enabled-disabled information indicating whether each of the functions F1 to F6 of the functional unit 4, the functional unit 5, or the controller 6 is enabled or disabled, a control signal output unit 62 for acquiring the enabled-disabled information stored in the enabled-disabled information storage 61 to output a signal for switching between enabling and disabling of each of the functions F1 to F6, a unit communication interface 63 as an interface between the control signal output unit 62 and the communication line CL, and a network interface 67 as a communication interface between the engineering tool 100 and, for example, the enabled-disabled information storage 61 or the switch circuit 66.

The control signal output unit 62 outputs the signals below to control enabling or disabling of the functions F1 to F6 based on the enabled-disabled information stored in the enabled-disabled information storage 61.

When the enabled-disabled information for the function F1 stored in the enabled-disabled information storage 61 is enabled, the control signal output unit 62 outputs a signal to control the switch circuit 66 in an ON state to enable the function F1.

When the enabled-disabled information for the function F1 stored in the enabled-disabled information storage 61 is disabled, the control signal output unit 62 outputs a signal to control the switch circuit 66 in an OFF state to disable the function F1.

When the enabled-disabled information for the function F2 stored in the enabled-disabled information storage 61 is enabled, the control signal output unit 62 outputs a signal to control the switch circuit 66 in an ON state to enable the function F2.

When the enabled-disabled information for the function F2 stored in the enabled-disabled information storage 61 is disabled, the control signal output unit 62 outputs a signal to control the switch circuit 66 in an OFF state to disable the function F2.

When the enabled-disabled information for the function F3 stored in the enabled-disabled information storage 61 is enabled, the control signal output unit 62 outputs a signal to control the switch circuit 43 in an ON state to enable the function F3.

When the enabled-disabled information for the function F3 stored in the enabled-disabled information storage 61 is disabled, the control signal output unit 62 outputs a signal to control the switch circuit 43 in an OFF state to disable the function F3.

When the enabled-disabled information for the function F4 stored in the enabled-disabled information storage 61 is enabled, the control signal output unit 62 outputs a signal to control the switch circuit 43 in an ON state to enable the function F4.

When the enabled-disabled information for the function F4 stored in the enabled-disabled information storage 61 is disabled, the control signal output unit 62 outputs a signal to control the switch circuit 43 in an OFF state to disable the function F4.

When the enabled-disabled information for the function F5 stored in the enabled-disabled information storage 61 is enabled, the control signal output unit 62 outputs a signal to control the switch circuit 53 in an ON state to enable the function F5.

When the enabled-disabled information for the function F5 stored in the enabled-disabled information storage 61 is disabled, the control signal output unit 62 outputs a signal to control the switch circuit 53 in an OFF state to disable the function F5.

When the enabled-disabled information for the function F6 stored in the enabled-disabled information storage 61 is enabled, the control signal output unit 62 outputs a signal to control the switch circuit 53 in an ON state to enable the function F6.

When the enabled-disabled information for the function F6 stored in the enabled-disabled information storage 61 is disabled, the control signal output unit 62 outputs a signal to control the switch circuit 53 in an OFF state to disable the function F6.

The control signal output unit 62 detects a command for initializing the PLC 2 through, for example, the unit communication interface 63, and acquires the enabled-disabled information from the enabled-disabled information storage 61.

### Details of Engineering Tool 100

The engineering tool 100 has the configuration described below.

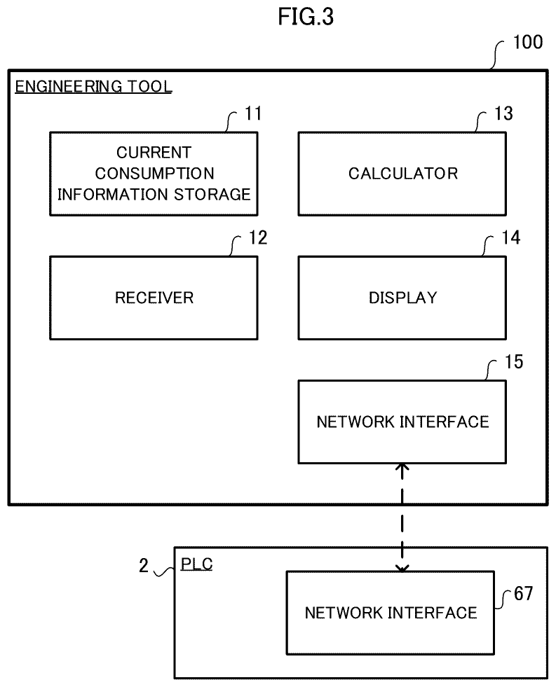

The engineering tool 100 illustrated in FIG. 3 includes a current consumption information storage 11 for storing current consumption information indicating a value of a current consumed by the functional unit 4, the functional unit 5, or the controller 6, a receiver 12 for receiving an instruction to enable or disable the functions F1 to F6 included in the functional unit 4, the functional unit 5, or the controller 6, a calculator 13 for acquiring an instruction to enable or disable the functions F1 to F6 received by the receiver 12, acquiring the value of the current consumed by the functional unit 4, the functional unit 5, or the controller 6 from the current consumption information storage 11, and adding these values together to calculate a total value of a current consumed by the functional unit 4, the functional unit 5, and the controller 6, a display 14 for displaying the total value calculated by the calculator 13, and a network interface 15 for connecting the engineering tool 100 to the communication line CL.

### Current Consumption Information Storage 11

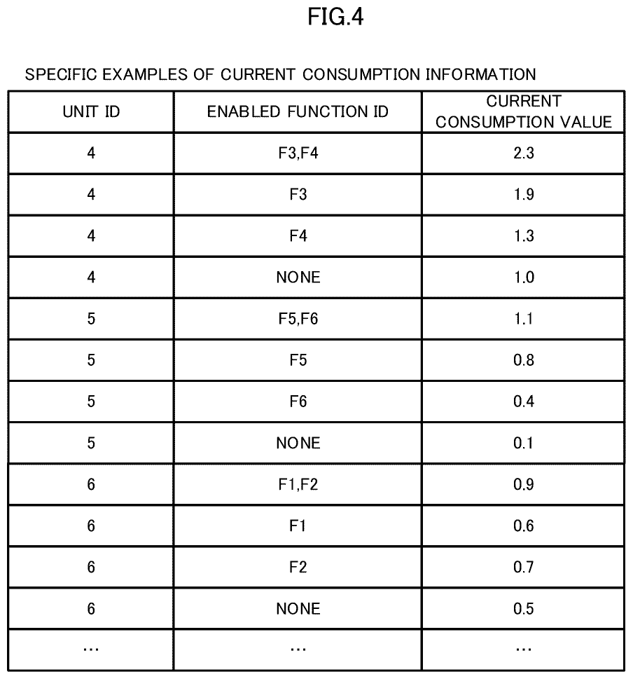

As illustrated in FIG. 4, the current consumption information storage 11 stores identification (ID) information (identifier) for the functional unit 4, the functional unit 5, or the controller 6 in association with combination information including all combinations of the functions included in the functional unit 4, the functional unit 5, or the controller 6. Each combination indicates whether the corresponding function is enabled or disabled. The current consumption information storage 11 also stores a value of current consumption as a value of the current consumed by the functional unit 4, the functional unit 5, or the controller 6. The combination information indicates whether each function is enabled or disabled. This information can be used to determine the varying value of the current consumed by the functional unit 4, the functional unit 5, or the controller 6.

The functional unit 4 has four combinations of the function F3 and the function F4 being enabled or disabled. For all the four combinations, the ID for the functional unit 4 is associated with the ID for the enabled function and the value of the current consumed by the functional unit 4.

Similarly, the functional unit 5 has four combinations of the function F5 and the function F6 being enabled or disabled. For all the four combinations, the ID for the functional unit 5 is associated with the ID for the enabled function and the value of the current consumed by the functional unit 5.

The controller 6 has four combinations of the function F1 and the function F2 being enabled or disabled. For all the four combinations, the ID for the controller 6 is associated with the ID for the enabled function and the value of the current consumed by the controller 6.

The combination information is prestored in the current consumption information storage 11 when the user operates the engineering tool 100. Storing the combination information into the current consumption information storage 11 is an example step of storing current consumption information.

When no function is enabled, NONE is stored into the current consumption information storage 11 as the ID for the enabled function.

For example, when both the functions F1 and F2 in the controller 6 are set to be disabled, the ID for the controller 6 is stored in association with NONE in the current consumption information storage 11. In this case, neither the function F1 nor the function F2 in the controller 6 is used. The value of the current consumption 0.5 in the example represents the basic current consumed by the controller 6.

In FIG. 4, the functional unit 4, the functional unit 5, or the controller 6 has the ID 4, 5, or 6, together with the ID F1, F2, F3, F4, F5, or F6 for the functions, but may have a different ID for each unit or function.

The value of the current consumption is set by the manufacturer when, for example, the functional unit 4, the functional unit 5, or the controller 6 is designed.

The functional unit 4, the functional unit 5, and the controller 6 include the functions F1 to F6, each of which is set to be enabled or disabled. These units may be collectively referred to as units.

### Receiver 12

Referring back to FIG. 3, the receiver 12 receives the ID for the functional unit 4, the functional unit 5, or the controller 6 selected by the user to be enabled, and the ID for the function selected by the user to be enabled.

More specifically, upon receiving an input from the user, the receiver 12 sets the ID for the functional unit 4, the functional unit, 5 or the controller 6 selected by the user for use as being enabled, and sets the ID for the function selected by the user for use as being enabled. As described in detail later, the receiver 12 provides these IDs to the PLC 2 through the network interface 15.

In some embodiments, the receiver 12 may receive an operation for switching to enable the function from being disabled, may receive an operation for switching to disable the function from being enabled, or may receive both of these operations. Receiving the operation from the user is an example step of receiving.

### Calculator 13

The calculator 13 acquires the ID for the functional unit 4, the functional unit 5, or the controller 6 set as being enabled by the receiver 12, and the ID for the function set as being enabled by the receiver 12. Subsequently, the calculator 13 acquires, from the current consumption information storage 11, the value of a current consumed by the functional unit 4, the functional unit 5, or the controllers 6 corresponding to the combination of functions selected as being enabled, and adds these values together to calculate the total value of a current consumed by the functional unit 4, the functional unit 5, and the controller 6 selected as being enabled.

### Display 14

The display 14 displays the value of a rated current consumption RC of the power supply unit 3 and the total value of current consumption calculated by the calculator 13. The display 14 updates the value to be displayed every time the calculator 13 recalculates to change the total value.

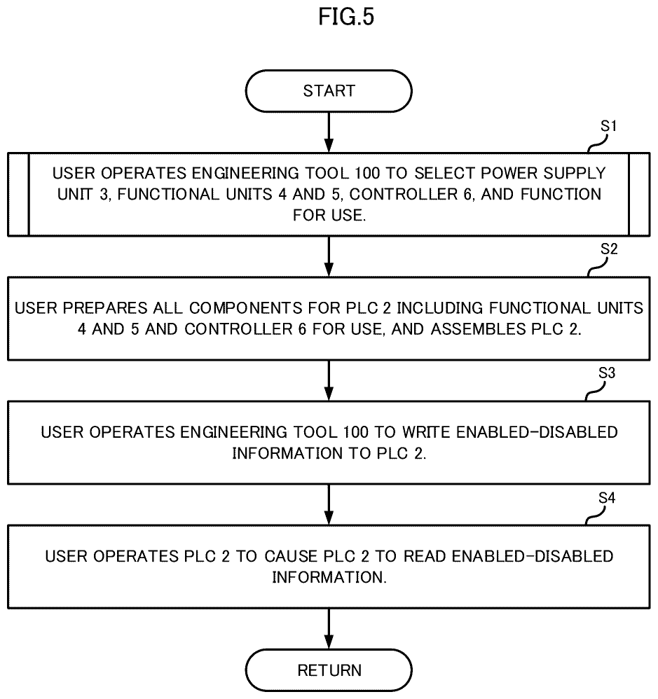

A procedure for operating the engineering tool 100 having the above configuration to set up the power supply unit 3, the functional unit 4, the functional unit 5, or the controller 6 to operate the PLC 2 is described with reference to FIG. 5.

First, the user operates the engineering tool 100 to select the power supply unit 3, the functional unit 4, the functional unit 5, the controller 6, and a function for use (S1). In this state, the engineering tool 100 is not connected to the PLC 2 not assembled yet.

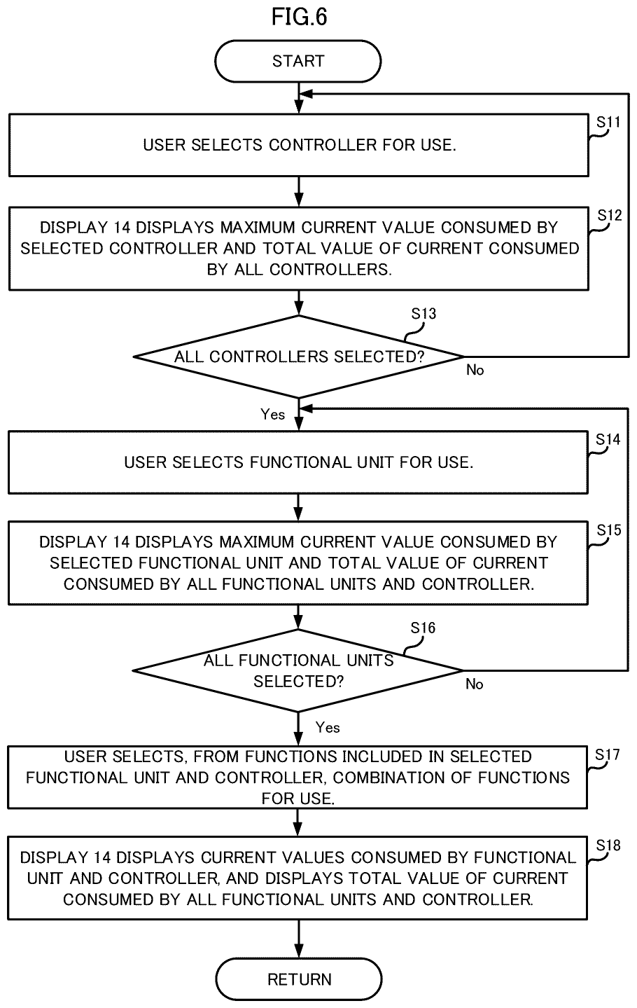

The processing in step S1 (in FIG. 5) is now described in detail with reference to FIG. 6. In step S1, the user operates the engineering tool 100 to select the power supply unit 3, the functional unit 4, the functional unit 5, and the controller 6 to be incorporated in the PLC 2, together with the function for use.

In the example described below, the user selects the power supply unit 3 with the rated current of 3.0 A, the functional unit 4, the functional unit 5, and the controller 6. The user does not use the function F4 but uses the function F3 in the functional unit 4, does not use the function F5 but uses the function F6 in the functional unit 5, and does not use the function F1 or the function F2 in the controller 6. Each function may be referred to as F1, F2, F3, F4, F5, or F6 using the ID for the corresponding function.

First, the user selects the controller 6 for use (S11).

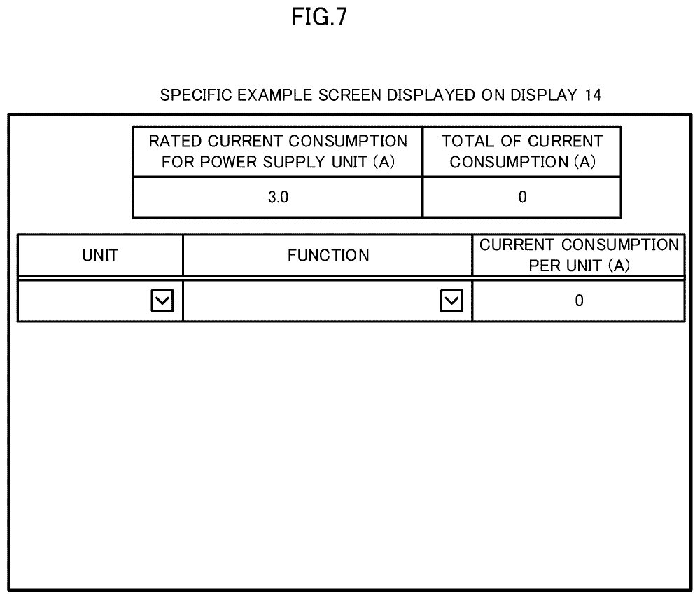

More specifically, the user refers to a screen displayed on the display 14 in FIG. 7, and operates the engineering tool 100 to expand a drop-down list collapsed in a unit column and select the functional unit 4, the functional unit 5, or the controller 6.

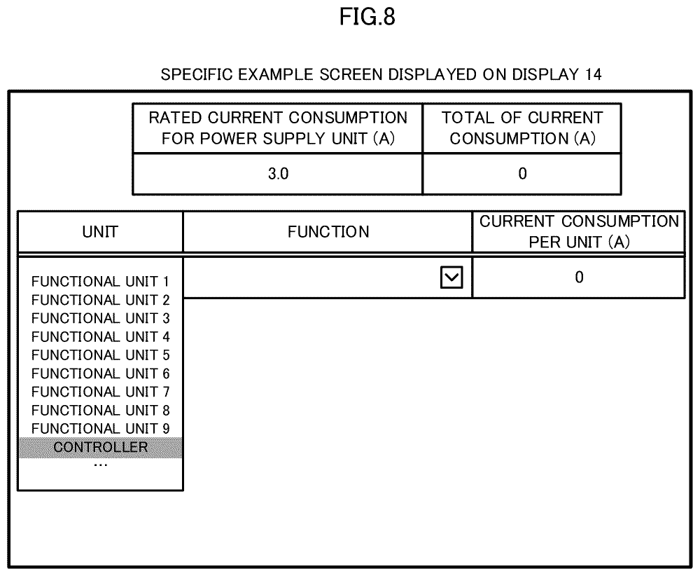

As illustrated in FIG. 8, the illustrated drop-down list includes the units such as the functional unit 1, the functional unit 2, . . . , the functional unit 9, and the controller.

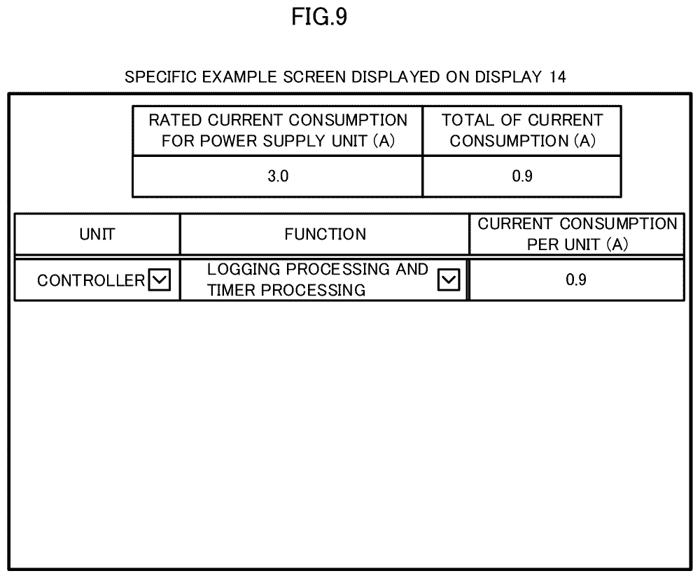

As illustrated in FIG. 9, the user selects, from these options, the controller for use. The display 14 displays the maximum value of the current consumed by the selected controller and the total value of the current consumed by all the controllers (S12 in FIG. 6).

More specifically, the display 14 reads, from the current consumption information storage 11, the combination of functions that consumes the maximum current when the controller 6 is enabled, and displays logging processing and timer processing in the function column and the value 0.9 in the current consumption per unit column. The display 14 also displays the value 0.9 in the total of current consumption column as the total value of the current consumed by the enabled units.

In FIG. 6, the processing advances to step S14 when all the controllers are selected (Yes in S13). Otherwise (No in S13), the processing returns to step S11.

In this example including a single controller 6, all the controllers 6 are selected (Yes in S13). The processing thus advances to step S14.

The user selects the functional unit 4 or the functional unit 5 for use (S14 in FIG. 6).

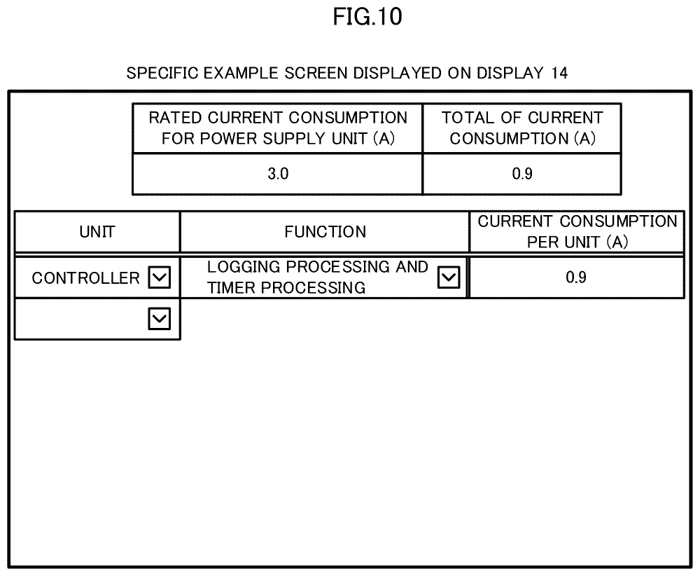

More specifically, the user refers to a screen displayed on the display 14 in FIG. 10, and operates the engineering tool 100 to expand the drop-down list for selecting the functional unit 4, the functional unit 5, or the controller 6.

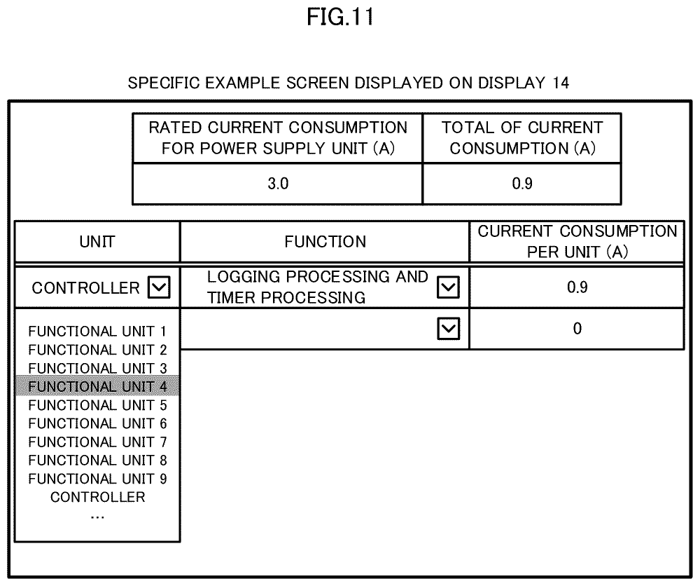

As illustrated in FIG. 11, the illustrated drop-down list includes the units such as the functional unit 1, the functional unit 2, . . . , the functional unit 9, and the controller.

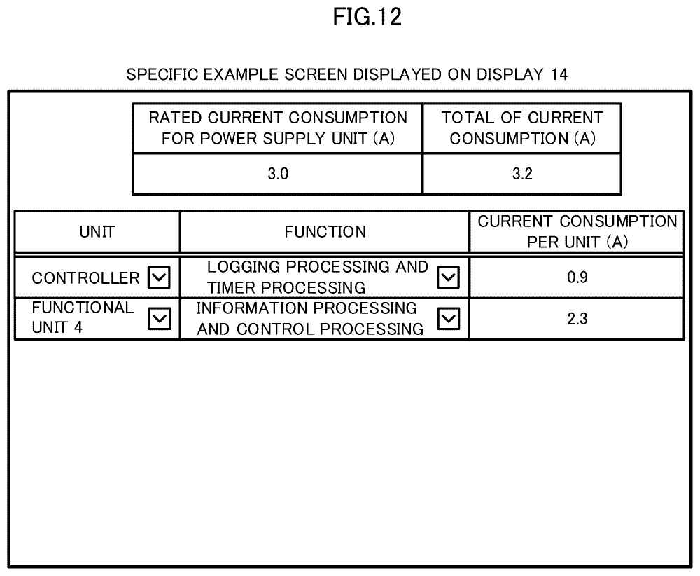

As illustrated in FIG. 12, the user selects, from these options, the functional unit 4 for use.

The display 14 displays the maximum value of the current consumed by the selected functional unit and the total value of the current consumed by all the functional units and the controller (S15).

More specifically, the display 14 reads, from the current consumption information storage 11, the combination of functions that consumes the maximum current when the functional unit 4 is enabled, and displays information processing and control processing in the function column and the value 2.3 in the current consumption per unit column. The display 14 also displays the value 3.2 in the total of current consumption column as the total value of the current consumed by these enabled units.

When all the functional units, or both the functional units 4 and 5 are selected for use (Yes in S16 in FIG. 6), the processing advances to step S17. Otherwise (No in S16), the processing returns to step S14.

In this example, of the functional units 4 and 5, the functional unit 5 is not selected for use (No in S16), and the processing returns to step S14.

The user selects the functional unit 4 or the functional unit 5 for use (S14 in FIG. 6).

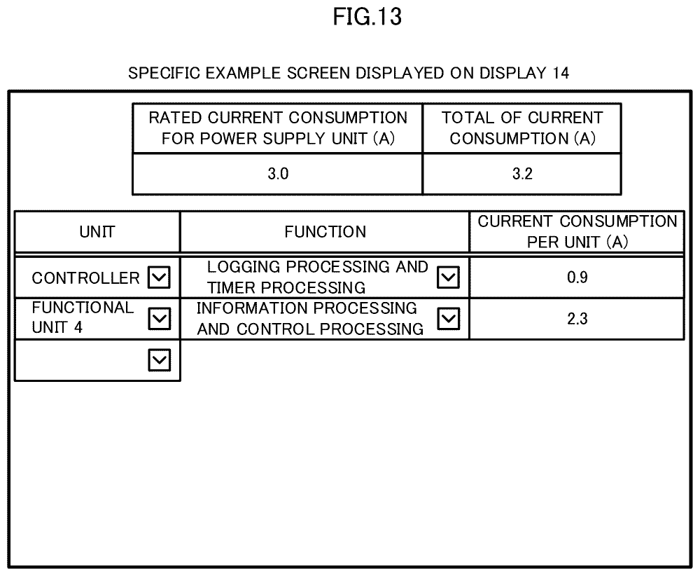

More specifically, the user refers to a screen displayed on the display 14 in FIG. 13, and operates the engineering tool 100 to expand the drop-down list for selecting the functional unit 4, the functional unit 5, or the controller 6.

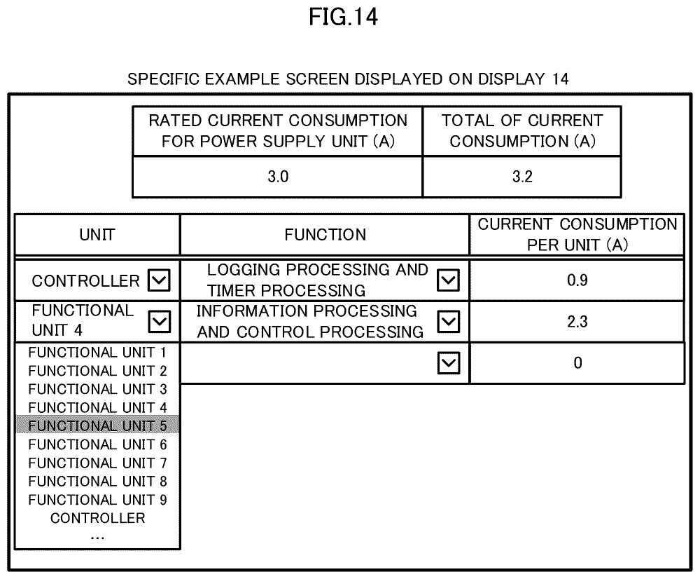

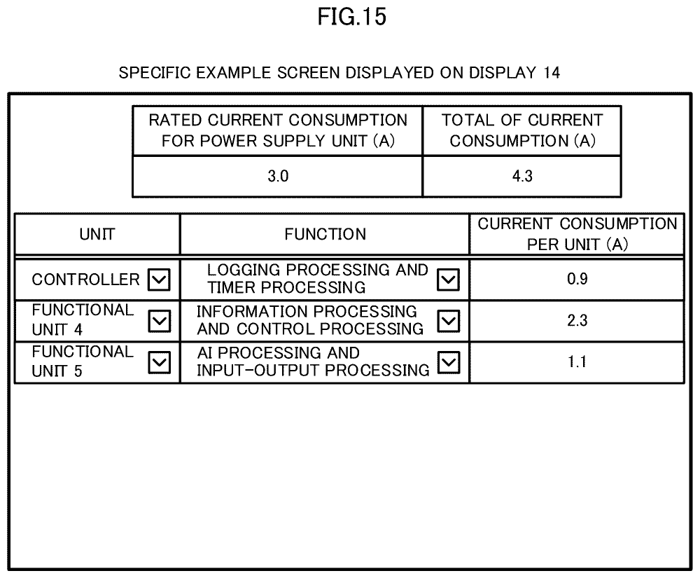

As illustrated in FIG. 14, the drop-down list includes the units such as the functional unit 1, the functional unit 2, . . . , the functional unit 9, and the controller. As illustrated in FIG. 15, the user selects, from these options, the functional unit 5 for use.

The display 14 displays the maximum value of the current consumed by the selected functional unit and the total value of the current consumed by all the functional units and the controller (S15).

More specifically, the display 14 reads, from the current consumption information storage 11, the combination of functions that consumes the maximum current when the functional unit 5 is enabled, and displays AI processing and input-output processing in the function column and the value 1.1 in the current consumption per unit column. The display 14 also displays the value 4.3 in the total of current consumption column as the total value of current consumed by these enabled units.

When all the functional units, or both the functional units 4 and 5 are selected for use (Yes in S16 in FIG. 6), the processing advances to step S17. Otherwise (No in S16), the processing returns to step S14.

In this example, all the functional units, or both the functional units 4 and 5 are selected for use (Yes in S16 in FIG. 6), and the processing advances to step S17.

The user refers to the current consumption per unit column and the total of current consumption column to acquire the maximum value of the current consumed by the controller 6 when the controller 6 is enabled, and the total value of the current consumed by all the units including the controller 6. This allows the user to, in step S17 and subsequent processing steps, set each function in the controller 6 to be enabled or disabled as appropriate for the value of the current consumed by the controller 6.

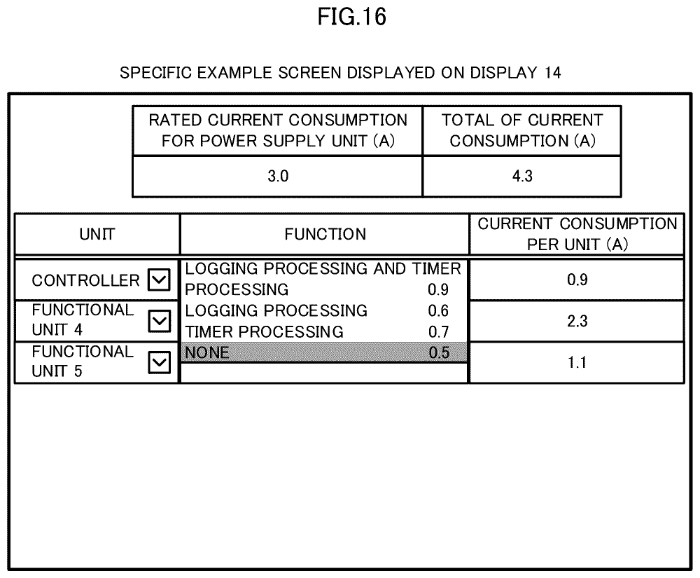

As illustrated in FIG. 16, the user uses neither the function F1 nor the function F2 in the controller 6. Thus, the user expands the drop-down list in the function column in the controller row, the user selects NONE (S17 in FIG. 6).

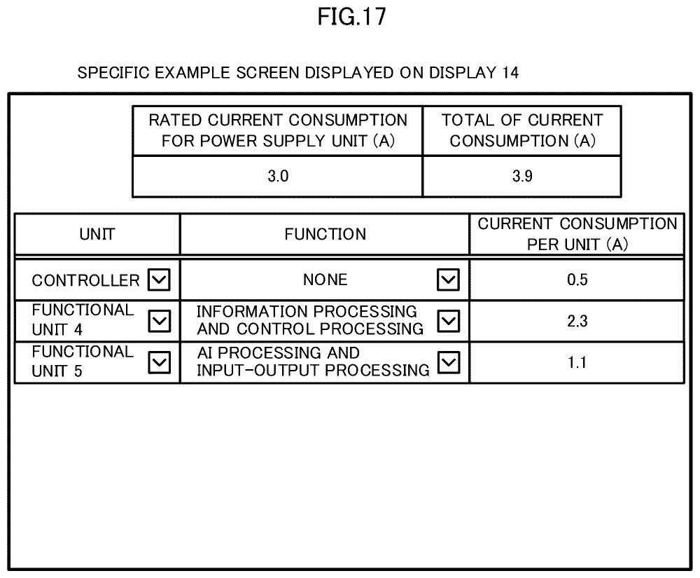

FIG. 17 is a diagram of a specific example screen to be displayed on the display 14 immediately after the user selects the above option. The display 14 displays the value 0.5 in the current consumption per unit column in the controller row, and the value 3.9 in the total of current consumption column. The display 14 reads, from the current consumption information storage 11, the value of the current consumed when neither the function F1 nor the function F2 in the controller 6 is used, and updates the display.

The user also selects the functions F3 and F6 for use in the functional unit 4 and the functional unit 5 (S17 in FIG. 6).

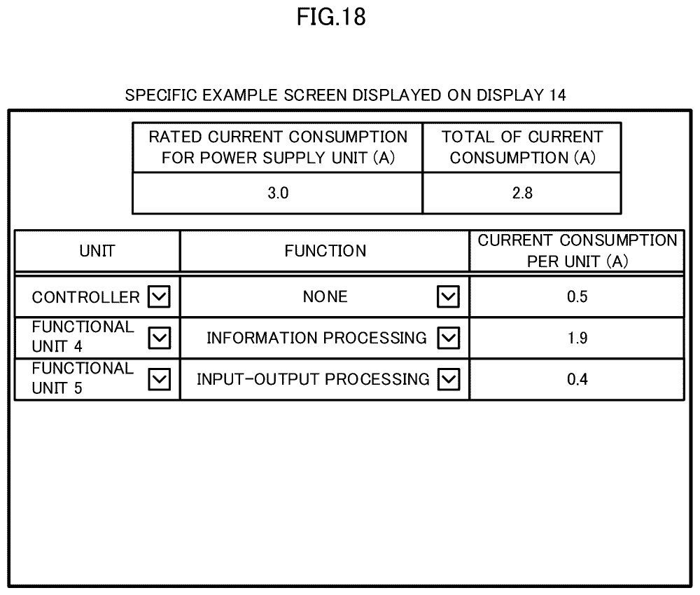

As illustrated in FIG. 18, the display 14 displays the value 0.5 as the current consumed by the controller 6, the value 1.9 as the current consumed by the functional unit 4, the value 0.4 as the current consumed by the functional unit 5, and the value 2.8 as the total value of current consumed by all these units (S18 in FIG. 6).

The above operations are received by the receiver 12, and when the receiver 12 receives each operation, the display 14 updates the information for display.

The user performs the procedure in FIG. 6 to cause the display 14 to, every time the combination of functions for use in the functional unit 4, the functional unit 5, or the controller 6 is changed, update the total value of the current consumed by all these units. This allows the user to acquire the total value of the current consumed in the PLC 2 that varies depending on the change of functions for use.

In the examples described above, the power supply unit 3 with the rated current consumption RC of 3.0 A is used.

When the rated current consumption RC of the currently selected power supply unit 3 is not sufficient for the functions selected by the user for use, the user may select other models for the power supply unit 3.

For example, with three model candidates for the power supply unit 3, or the models with the rated current consumption RC of 2.0 A, 3.0 A, and 4.0 A, the user easily selects the model with the RC of 3.0 requested by the rated current consumption RC as the value closest to the value of the rated current consumption RC.

Thus, with the engineering tool 100, before the PLC 2 is assembled, the user may select the power supply unit 3 with the rated current appropriate for the functions for use.

Displaying the value of the current consumed by the functional unit 4, the functional unit 5, or the controller 6 on the display 14 or displaying the total value of the current consumed by the enabled functional unit 4, the enabled functional unit 5, and the enabled controller 6 on the display 14 is an example step of displaying.

The functions selected for use may be changed before the functional unit 4, the functional unit 5, and the controller 6 are selected for use.

Referring back to FIG. 5, the procedure after the power supply unit 3, the functional unit 4, the functional unit 5, and the controller 6 are selected to form the PLC 2 is described.

The user prepares all the components for the PLC 2 including the functional unit 4, the functional unit 5, and the controller 6 for use, and assembles the PLC 2 (S2).

Subsequently, the user operates the engineering tool 100 to write the enabled-disabled information to the PLC 2 (S3).

More specifically, the user connects the engineering tool 100 to the assembled PLC 2, and operates the engineering tool 100 to write the enabled-disabled information to the enabled-disabled information storage 61 in the controller 6. The receiver 12 has the IDs for the functional unit 4, the functional unit 5, and the controller 6 selected as being enabled and the IDs for the functions selected as being enabled, and stores these IDs into the enabled-disabled information storage 61 through the network interface 15.

In the final processing, the user operates the PLC 2 to cause the PLC 2 to read the enabled-disabled information (S4). More specifically, the controller 6 detects a command to initialize the PLC 2 from the user, and acquires the enabled-disabled information from the enabled-disabled information storage 61.

The user may operate the engineering tool 100 to cause the PLC 2 to read the enabled-disabled information.

The enabled-disabled information storage 61 stores, as the enabled-disabled information, the IDs 4, 5, and 6 for the functional unit 4, the functional unit 5, and the controller 6, together with the IDs F3 and F6 for the functions F3 and F6. Thus, through the procedure described above, the PLC 2, in which the functions F3 and F6 are selected to be enabled from the functions F1 to F6 in the functional unit 4, the functional unit 5, and the controller 6, is operated. The enabled-disabled information storage 61 may include the IDs for disabled functions.

### Embodiment 2

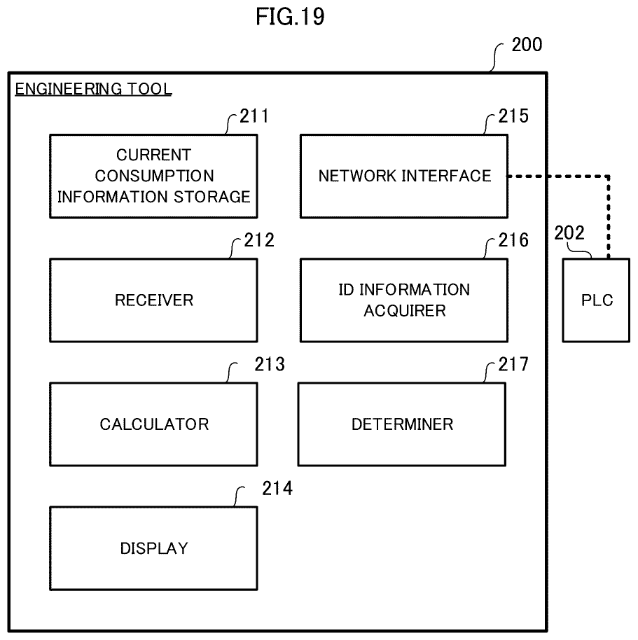

FIG. 19 illustrates an engineering tool 200 in Embodiment 2. The engineering tool 200 includes a function to determine whether a PLC 202 has the configuration in accordance with information set by the engineering tool 100. The information indicates whether each of the functional unit 4, the functional unit 5, the controller 6, and the functions included in these units are to be enabled or disabled.

The engineering tool 200 includes, in addition to the configuration in the engineering tool 100, an ID information acquirer 216 for acquiring IDs for functional units 204 and 205 connected to the PLC 202, and a determiner 217 for determining whether the PLC 202 has the configuration in accordance with the IDs acquired by the ID information acquirer 216. A current consumption information storage 211, a receiver 212, a calculator 213, a display 214, and a network interface 215 each have functions equivalent to the functions of the current consumption information storage 11, the receiver 12, the calculator 13, the display 14, and the network interface 15 in the engineering tool 100.

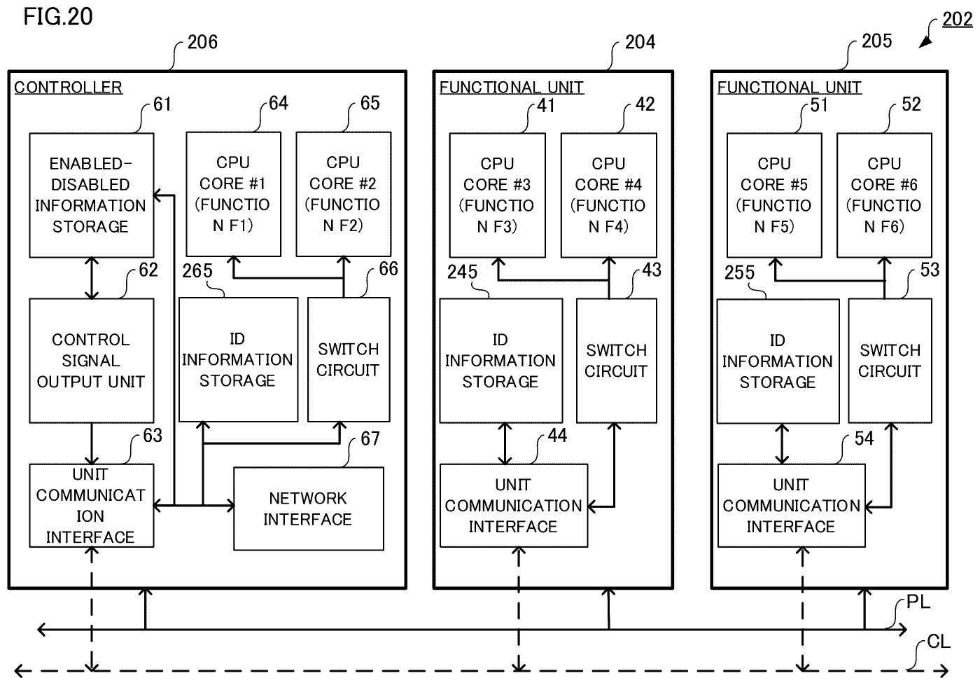

As illustrated in FIG. 20, the PLC 202 includes the functional unit 204, the functional unit 205, and a controller 206 respectively including an ID information storage 245, an ID information storage 255, and an ID information storage 265 each storing an ID specific to the corresponding unit. The ID information storages 245, 255, and 265 are each connected to the communication line CL through the unit communication interfaces 44, 54, and 63. Network devices connected to the communication line CL acquire, through the communication line CL, the IDs for the functional unit 204, the functional unit 205, and the controller 206 from the ID information storages 245, 255, and 265.

When the user connects the engineering tool 200 to the PLC 202, the ID information acquirer 216 acquires, through the network interface 215, the ID information for the functional unit 204, the functional unit 205, and the controller 206 connected to the communication line CL.

For example, the engineering tool 200 transmits a packet to which all the network devices connected to the communication line CL are to respond.

The determiner 217 detects the network devices responding to the transmitted packet, and acquires the IDs for the detected network devices from the ID information storages 245, 255, and 265.

The determiner 217 determines whether the IDs acquired from the ID information storages 245, 255, and 265 and the IDs for the functional unit 204, the functional unit 205, and the controller 206 set as being enabled by the receiver 212 match. When the determiner 217 determines that these IDs do not match, the determiner 217 causes the display 214 to display incompatible information including, for example, the IDs for the functional unit 204, the functional unit 205, and the controller 206 that do not match, and the number of unmatched units. The determiner 217 also determines whether the IDs for the functions stored as being enabled in the enabled-disabled information storage 61 match the IDs for the functions set as being enabled by the receiver 212. When the determiner 217 determines that these IDs do not match, the determiner 217 causes the display 214 to display incompatible information including, for example, the IDs for the unmatched functions and the number of unmatched functions.

The engineering tool 200 allows the user to easily confirm whether the PLC 202 has the configuration as set by the engineering tool 200.

### Modifications

The engineering tools 100 or 200 sets enabling or disabling of the functions on the PLC 2 or PLC 202. An engineering tool 300 described below sets the degree of restriction of the functions for use using a parameter.

The engineering tool 300 is described below, focusing on the differences from the engineering tools 100 and 200. The same reference signs denote the same or equivalent components described above.

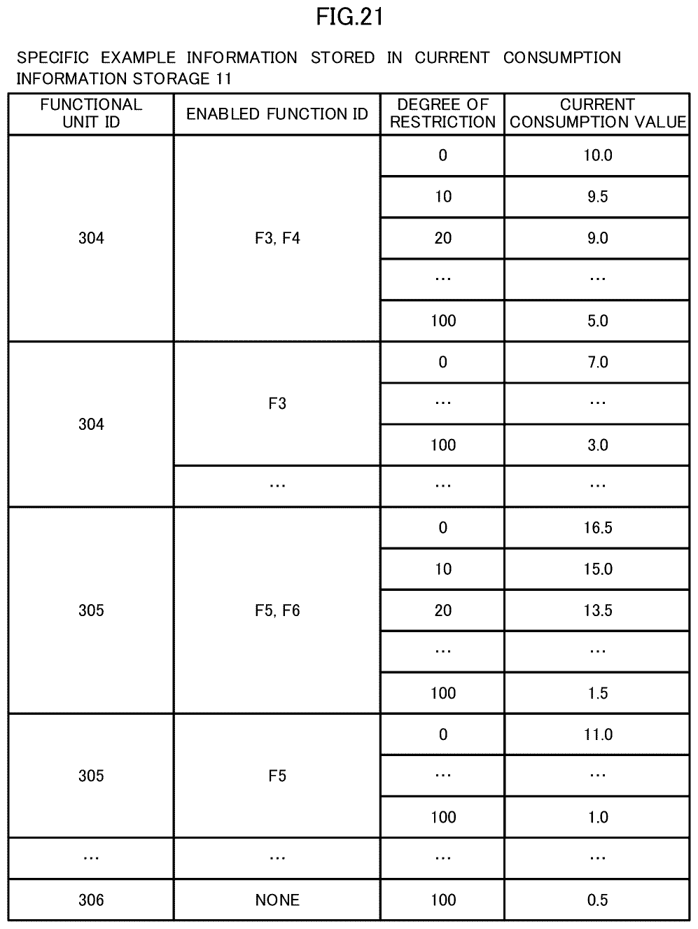

As illustrated in FIG. 21, the current consumption information stored in the current consumption information storage 11 in the engineering tool 300 includes IDs for a functional unit 304, a functional unit 305, and a controller 306, IDs for the enabled functions, the value of current consumption, and a numerical value indicating the degree of restriction in the range of 0 to 100.

The numerical value of 0 as the degree of restriction indicates that, for example, the function is enabled and not restricted. The numerical value of 100 as the degree of restriction indicates that, for example, the function is enabled and restricted by a maximum degree. Each numerical value between 0 and 100 indicates that, for example, the function is restricted by a degree Corresponding to the numerical value.

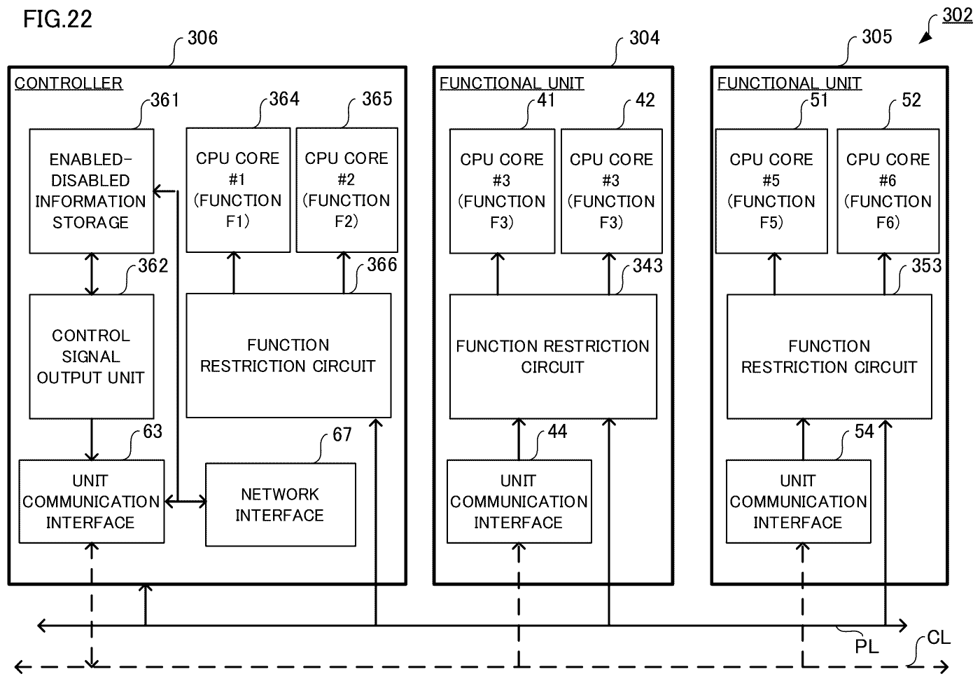

FIG. 22 is a diagram of a PLC 302 including the functional unit 304, the functional unit 305, and the controller 306. The engineering tool 300 is connected to the PLC 302.

The functional unit 304 includes, in place of the switch circuit 43, a function restriction circuit 343 that restricts the operations of the enabled functions in the functional unit 304. The functional unit 305 includes, in place of the switch circuit 53, a function restriction circuit 353 that restricts the operations of the enabled functions in the functional unit 305. The controller 306 includes a function restriction circuit 366 that restricts the operations of the enabled functions in the controller 306.

The CPU cores 41 and 42 in the functional unit 304 are connected to the power line PL through the function restriction circuit 343. The CPU cores 51 and 52 in the functional unit 305 are connected to the power line PL through the function restriction circuit 353. CPU cores 364 and 365 in the controller 306 are connected to the power line PL through the function restriction circuit 366.

The controller 306 includes, in place of the enabled-disabled information storage 61, a restriction information storage 361 for storing the restriction information.

A control signal output unit 362 reads values stored in the restriction information storage 361, and sets, based on the read values, for example, a CPU core clock for the CPU core 41, 42, 51, 52, 364, or 365 implementing each function at a value in the range of the minimum to maximum values.

For example, the CPU core 41 operates with a variable frequency from 1.0 to 3.0 GHz. For the values 0, 10, 20, . . . , 100 stored in the restriction information storage 361, the control signal output unit 362 outputs a signal for controlling the frequency of the CPU core 41 at 1.0, 1.2, 1.4, . . . , 3.0 GHz.

The engineering tool 300 can set the rated current to finer values than in the engineering tool 100 or 200.

### Hardware Configuration

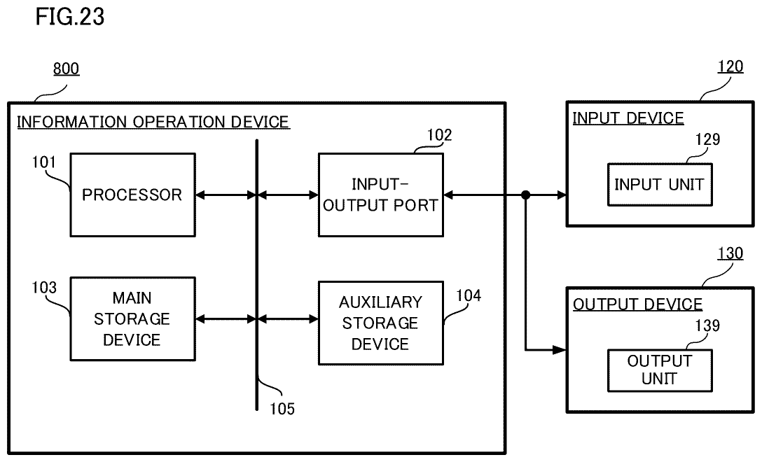

The engineering tool 100, 200, or 300 described above can be implemented by, for example, an information operation device 800 having the hardware configuration illustrated in FIG. 23.

The information operation device 800 includes a processor 101 for performing various operations, an input-output port 102 for communicating with other devices such as an input device 120 or an output device 130, a main storage device 103 such as a dynamic random-access memory (DRAM) or a static random-access memory (SRAM) for temporarily storing information, an auxiliary storage device 104 such as a hard disk drive (HDD) or a solid-state drive (SSD) for permanently storing information, and a bus 105 as a path for information exchanged between the processor 101, the input-output port 102, the main storage device 103, and the auxiliary storage device 104.

The input device 120 receives inputs of external data. The input device 120 includes, for example, a human interface device such as a mouse, a keyboard, a touchscreen, and a microphone. The input device 120 includes an input unit 129 that detects, for example, the state of buttons or keys to input information.

The input device 120 may be a reception interface that detects signals transmitted from other devices, such as a parallel bus or a serial bus.

The output device 130 can output data externally. The output device 130 includes, for example, a display or a printer. The output device 130 may include an output unit 139 such as a light-emitting diode or a speaker.

The processor 101 is an example hardware for implementing the calculator 13 illustrated in FIG. 3. The input device 120 is an example hardware for implementing the receiver 12 illustrated in FIG. 3.

The method described in each of the above embodiments is implementable as a computer-executable program stored in a non-transitory storage medium, such as a magnetic disk, an optical disc, a magneto-optical disk, or a semiconductor memory executable by various devices. A computer that implements the embodiments of the present disclosure reads a program stored in the non-transitory storage medium and performs the processes described above under control in accordance with the program.

The present disclosure is not limited to the embodiments described above and may be implemented in other embodiments with modifications as appropriate.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

100, 200, 300 Engineering tool
2, 202, 302 PLC
3 Power supply unit
4, 5, 204, 205, 304, 305
6, 206, 306 Controller
Functional unit
7 Base unit
11, 211 Current consumption information storage
12, 212 Receiver
13, 213 Calculator
14, 214 Display
15, 67, 215 Network interface
44, 54, 63 Unit communication interface
61 Enabled-disabled information storage
62, 362 Control signal output unit
41, 42, 51, 52, 64, 65, 364, 365 CPU core
43, 53, 66 Switch circuit
101 Processor
102 Input-output port
103 Main storage device
104 Auxiliary storage device
105 Bus
120 Input device
129 Input unit
130 Output device
139 Output unit
216 ID information acquirer
217 Determiner
245, 255, 265 ID information storage
343, 353, 366 Function restriction circuit
361 Restriction information storage
800 Information operation device
CL Communication line
F1, F2, F3, F4, F5, F6 Function
PL Power line
RC Rated current consumption

1. A system construction assistance device, comprising:
a current consumption information storage to store a value of a current consumed by a unit included in a programmable logic controller, the unit having a function that is capable of being disabled, the value of the current being a value of a current consumed by the unit with the function being disabled; and
a display to acquire, from the current consumption information storage, the value of the current consumed by the unit with the function being disabled and display the acquired value.

2. The system construction assistance device according to claim 1, wherein
the current consumption information storage stores the value of the current consumed by the unit in association with a combination of the function being disabled and a function being enabled.

3. The system construction assistance device according to claim 2, further comprising:
calculating circuitry to acquire values of currents consumed by a plurality of the units and add the acquired values to calculate a total value of the currents consumed by the plurality of units, wherein
the display acquires the total value calculated by the calculating circuitry and displays the acquired total value.

4. The system construction assistance device according to claim 3, wherein
each of the plurality of units includes an identification information storage to store identification information specific to the unit,
the system construction assistance device comprises
a receiver to receive an operation for enabling or disabling the function that is capable of being disabled, the function being included in each of the plurality of units;
identification information acquiring circuitry to acquire, from the identification information storage, the identification information for a unit, of the plurality of units, connected to the programmable logic controller; and
determining circuitry to determine whether the identification information for the unit acquired by the identification information acquiring circuitry matches identification information for a unit of the plurality of units set as being enabled by the receiver, and
when the determining circuitry determines that the identification information for the unit acquired by the identification information acquiring circuitry does not match the identification information for the unit set as being enabled by the receiver, the determining circuitry causes the display to display incompatible information including the identification information acquired by the identification information acquiring circuitry not matching the identification information set as being enabled by the receiver.

5. A system construction assistance device operation method, comprising:
storing, into a storage, a value of a current consumed by a unit included in a programmable logic controller, the unit having a function that is capable of being disabled, the value of the current being a value of a current consumed by the unit with the function being disabled; and
acquiring, from the storage, the value of the current consumed by the unit with the function being disabled, and displaying the acquired value.

6. A non-transitory computer-readable recording medium storing a program, the program causing a computer to perform operations comprising:
storing, into a storage, a value of a current consumed by a unit included in a programmable logic controller, the unit having a function that is capable of being disabled, the value of the current being a value of a current consumed by the unit with the function being disabled; and
acquiring, from the storage, the value of the current consumed by the unit with the function being disabled, and displaying, on a display, the acquired value.
